(19) United States
(12) Patent Application Publication
(10) Pub. No.: US 2007/0297276 A1
(43) Pub. Date: Dec. 27, 2007

(54) Mixing Apparatus

(76) Inventors: Beng Lai Koh, Singapore (SG); Khay Chuan Teo, Singapore (SG)

Correspondence Address: DICKSTEIN SHAPIRO LLP, 1825 EYE STREET NW, Washington, DC, 20006-5403, US

(21) Appl. No.: 11/659,507

(22) PCT Filed: Jul. 12, 2005
(86) PCT No.: PCT/SG05/00228

§ 371 Date: Feb. 6, 2007

(30) Foreign Application Priority Data
Aug. 10, 2004 (SG) 200404376-6

(51) Int. Cl. B01F 3/04; B01F 5/02

(52) U.S. Cl. 366/132

(57) ABSTRACT

A mixing apparatus for mixing a liquid and another substance which comprises a container (101) having at least one inlet (102) for introducing the liquid and the other substance into the container (101), a surface (105) inside the container against which the liquid and the other substance are arranged to splash and an outlet (103) for releasing a mixture of the substances from the container.

### FIELD OF INVENTION

The present invention relates to a mixing apparatus for mixing two or more substances to facilitate dissolution of one into the other. More particularly, but not exclusively, the present invention relates to a mixing apparatus for dissolution of a gas into a liquid.

### BACKGROUND OF INVENTION

There are many industrial processes that require dissolution of one or more fluids into another. However, the physical and chemical properties of the fluids sometimes limit their inter-miscibility, which hampers effective dissolution. Furthermore, there are occasionally additional constraints in energy, cost and space. Depending on the constraints, presently known industrial methods of dissolution are sometimes not applicable or effective.

An example of a process which requires dissolution of a not-so-soluble gas in a liquid solvent is the dissolution of ozone in coolant water of an air conditioning system or heat exchange system, as will now be described.

Coolant water of an air conditioning system is used to absorb heat in heat exchangers. The heat is subsequently removed from the coolant water by passing the warmed water through a cooling tower. The thus cooled water is then recycled into the air conditioning system for further heat exchange.

Typically, the coolant water enters the cooling tower through spray nozzles and is passed through perforated plates which breaks the spray into small water droplets. The droplets then drip into a reservoir in the cooling tower against a forced upward flow of air. The counter-current airflow causes some of the droplets to evaporate, thus removing heat from the main body of water.

The upward airflow in a cooling tower is created by a fan that continuously draws in large amount of unfiltered ambient air from the surrounding environment. Inevitably, airborne micro-organisms and organic pollutants from the environment are drawn in with the ambient air and they contaminate the coolant water. As the continuous re-cycling of the well-aerated coolant water provides a suitable condition for bacteria and algae to flourish, organic sludge and mineral deposit accumulates in the cooling system over time.

Some bacteria that thrive in such coolant water have been known to cause life-threatening infections. For example, Legionnaires' disease is contracted by inhaling airborne water droplets from air-conditioning systems infected with the bacteria Legion Ella. Therefore, since the water is used and recycled continuously, there is a need to clean and disinfect the water regularly.

One method of disinfecting coolant water on an industrial scale is to use ozone, which requires the aforementioned dissolution of ozone in water. Ozone is stronger than chlorine as an oxidant and is a powerful biocide that can be used over a wide pH range. The strong oxidising property of ozone can effectively control the growth of micro-organisms and reduces general biomass. In general, ozone treatment is considered one of the most powerful treatments for disinfecting industrial water.

Furthermore, ozone has a half-life of less than 10 minutes at ambient temperature and thus unwanted damage caused by the oxidising property of ozone to a system can be controlled by temperature regulation. When ozone breaks down, it becomes environmentally harmless oxygen that causes no corrosion or pollution problems.

However, there are limitations that hamper the industrial application of ozone as a disinfectant. Ozone has limited solubility in water and has a slow rate of mass transfer from gaseous to aqueous medium. The solubility of ozone in water in general is a major concern for many applications. Cold water at 10° C. or lower improves the solubility of ozone in water, i.e. solubility of ozone in water increases with a drop in temperature. However, chilling industrial water in bulk to a low temperature is an energy intensive process and is not always feasible.

A publication entitled “Ozone Injection—A Superior Choice for Clean-In-Place Applications” written by Kai E. Blakstad of Ozone Technology AS, Norway proposes a method for batch ozonation of water. Blakstad proposes using Venturi injectors for fine injection of ozone into process water to increase mass transfer rate of ozone into the liquid. However, other than increasing ozone-water interface area by the Venturi injector, the method does not consider other factors in ozone absorption. Therefore, ozone is merely dispersed and absorption is not fully optimised in the method.

On a laboratory scale, dissolution of ozone in water is performed by bubbling ozone-containing-air (10-20 ppm) through a sintered glass as a simple means of ozone-water mixing. A high-speed mechanical stirrer is often used to break the bubbles into tinier ones to increase surface area to improve ozone transfer to water.

Current industrial methods typically inject ozonated air with a high concentration of ozone into water. However, only some of the ozone is absorbed by the water but most escapes undissolved. The small amount of ozone that manages to be dissolved typically resides in levels as low as sub-ppm (<1 ppm) in the water. Consequently, the water may not be optimally disinfected. Furthermore, as such methods do not completely dissolve the ozonated air,. undissolved ozonated air is sometimes drawn into a process system and merges into gas pockets in the system. Furthermore, large quantity of undissolved ozone that has entered a process system and has not effectively decomposed into oxygen by the time it reaches an exhaust stream is emitted into the atmosphere and causes localized ground pollution. For example, large amount of undissolved ozone gas that is piped into a cooling tower can be released into the surrounding environment and an ozone destruction unit is thus needed to meet emission regulations.

To increase the amount of a gas dissolved in a liquid, EP0323954 proposes an apparatus comprising a container having freely rotating turbines that are spaced axially apart. The container is filled with a liquid and a gas is introduced into the container from the bottom. The gas forms bubbles that rise through the liquid, some of the gas dissolving in the liquid along the way. As they rise, the bubbles cause an upward current to flow through and turn the turbines. The rotating turbines break up the bubbles into smaller ones and thus increase gas-liquid contact area. The increase in interfacing area between gas and liquid improves the rate of mass transfer of the gas into the liquid. Gas bubbles that reach the surface of the liquid escape undissolved. Gas-pressure which builds up in the container assists gas dissolution. A variation of the method introduces a stream of slurry in a tangential angle into the container, such that the liquid is swirled to cause turbulence that prevents the bubbles from merging, thus maintaining a large gas-liquid interface. Basically, EP0323954 proposes increasing gas-liquid contact area to increase the rate of dissolution and the amount of dissolved gas. However, the method cannot be used in a continuous process as the liquid in the method is confined in a container and EP0323954 does not particularly pertain to dissolution of ozone in water for a continuous process.

It is an object of the invention to provide a novel mixing apparatus and/or a novel mixing method.

### SUMMARY OF THE INVENTION

In general terms, the invention proposes a mixing apparatus for mixing two or more substances.

This invention proposes in a first aspect a mixing apparatus for mixing a liquid and another substance, the apparatus comprising a container having at least one inlet for introducing the liquid and the other substance into the container, a surface inside the container against which the liquid and the other substance are arranged to splash and an outlet for releasing a mixture of the substances from the container.

In one embodiment, the surface is an assembly comprising a float, a stabiliser and an impingement surface, the assembly capable of floating on a liquid body of the mixed substances which varies in height as is determined by the inlet and outlet flowrates. In another embodiment, the surface is an impingement member having a fixed position which does not vary with the level of the liquid body.

In a second aspect the invention proposes a method of mixing a liquid and another substance comprising the steps of introducing the liquid and the other substance into a container, directing the liquid towards a surface so that the liquid and the other substance splash to form a mixture and releasing the resulting mixture from the container.

### BRIEF DESCRIPTION OF THE DRAWINGS

Embodiments of the invention will now be described by way of example, with reference to the accompanying drawings in which:

FIG. 1 is a schematic diagram of an embodiment of the invention having a guide and a floating impingement member in a mixing chamber;

FIG. 1a is a schematic diagram of another embodiment of the invention wherein the outlet flow control valve of the apparatus of FIG. 1 is removed and is replaced by an inverted U-shape pipe.

FIG. 2 illustrates how the embodiment of FIG. 1 is used with a cooling tower;

FIG. 3 is a schematic of a cooling system that has a cooling tower;

FIG. 4 is a schematic diagram of yet another embodiment of the invention having a floating impingement member without any guide; and

FIG. 5 is a schematic of yet another embodiment of the invention having an impingement member with a fixed position.

### DETAILED DESCRIPTION OF THE PREFERRED EMBODIMENTS

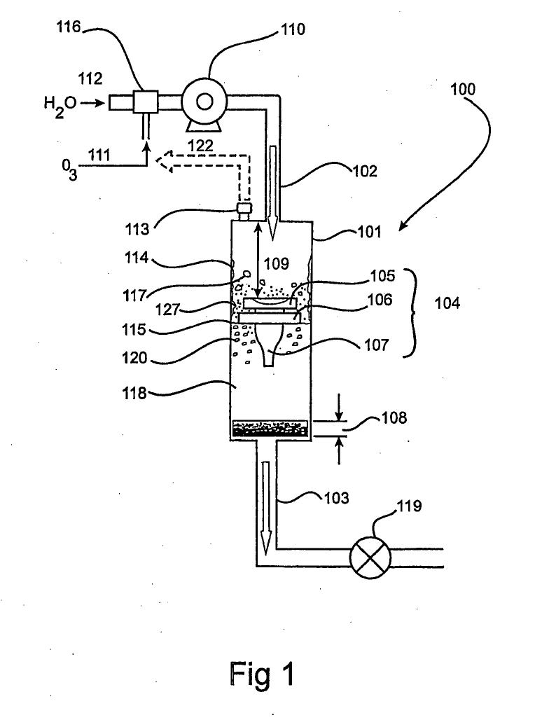

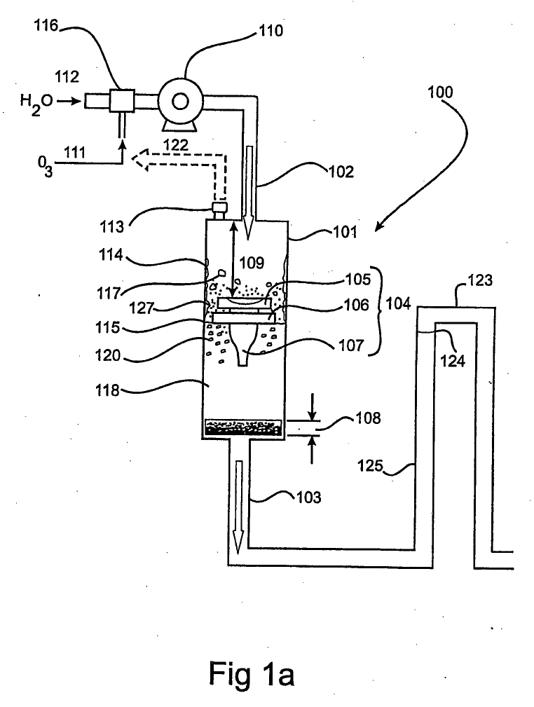

FIG. 1 shows a mixing apparatus 100 according to a first embodiment of the invention. The mixing apparatus 100 comprises a chamber 101 which is, preferably, of hollow cylindrical form. The chamber 100 is the main body of the mixing apparatus 100 and has an inlet 102, an outlet 103 and a pressure release valve 113. An assembly 104, comprising an impingement member or reflector 105, a stabiliser-106 and a float 107, is provided inside the chamber 101. The top surface of the impingement member 105 functions as an impingement surface and is preferably concave. Alternately, any other shape may be used, such as a flat, convex or a textured surface.

Upstream of the mixing apparatus 100, ozonated air 111 is produced by an ozone generator from dry air. The amount of ozone in the ozonated air 111 is typically in percentage by volume to tens of parts per million (ppm), e.g.: 79% nitrogen, 21% oxygen and 0.001% ozone (1%=10,000 ppm). The ozonated air 111 is dispersed into a stream of water 112, which is to be disinfected or oxidised, by a Venturi injector 116 or a diffuser (not shown). The absolute amount of ozone dispersed into the water 112 is adjustable. Generally, 0.1 Q g/hr of ozone is needed in a disinfection treatment, where Q is the volumetric flowrate of the water in m³/hr. The ozonated air 111 drawn into the water 112 forms a gas-liquid mixture; only a minute and insufficient quantity of the ozonated air 111 dissolves in the water 112 at this point and a mixture of ozonated air and water is formed (the water is actually aqueous ozone since some ozone has dissolved in the water).

The mixture of ozonated air and aqueous ozone is introduced as a continuous jet, under pressure by a conventional liquid pump 110, into the chamber 101 through the inlet 102. The jet of ozonated air-aqueous ozone mixture is directed onto the assembly 104. The disposition of the device is preferably with the inlet 102 being above assembly 104, so that gravity aids the flow of the mixture towards the assembly 104. The jet of ozonated air-aqueous ozone mixture hits the impingement member 105 and splashes to produces droplets 117, mist and foam 121. Some aqueous ozone is splashed onto the wall of the chamber 101 and forms a thin film of aqueous 114 ozone that flows down the wall. Eventually, a body of aqueous ozone 118 accumulates in the chamber 101 having a surface at a certain level 115. The floating element 107 causes the assembly 104 to float on the body of aqueous ozone 118. The stabiliser 106 reduces wobbling and excessive spinning of the assembly 104 when the assembly 104 rises or lowers in the chamber 101 according to changes in the level 115 of aqueous ozone. A gap of at least one millimetre is preferably kept between the edge of the assembly 104 and the chamber 101 wall to facilitate the movement of the assembly 104.

The level 115 of aqueous ozone 118 in the chamber 101 is maintained by regulating a continuous outflow at the outlet 103 against the in-flow at the inlet 102. The outlet 103 and has a means of moderating the aqueous ozone level control inside the vessel and/or the outlet flowrate, such as a valve 119 that is actuated by pressure, a liquid level detector or manually. Typically, the outlet 103 has a diameter larger than that of the inlet 102 to ensure a fail-safe operation which allows greater out-flow rate than in-flow rate if flow regulation fails.

The volume of aqueous ozone 118 in the chamber 101 is maintained such that a pre-determined height 109 is kept between the inlet 102 and the impingement member 105. The pre-determined height 109 is needed if the falling stream of ozone-water mixture is to have sufficient momentum to impact against the impingement member 105 surface to create a splash 117.

The atmosphere above the surface of aqueous ozone 115, which coincides with the pre-determined height 109, provides a “headspace” comprising undissolved ozonated air carried into the chamber 101. As the ozonated air-aqueous ozone mixture is fed into the chamber 101 continuously, the pressure in the headspace builds up. Concurrently, the partial pressure of ozone in the headspace also increases, which tilts the gaseous ozone/dissolved ozone equilibrium towards dissolution. Typically, a minimum level 108 of aqueous ozone is provided at the bottom of the chamber 101 having a depth of at least 1cm. The minimum level 108 of aqueous ozone provides a liquid surface which prevents the gas in the headspace from escaping through the outlet 103, thus allowing a build-up of gas pressure in the headspace. Therefore, the minimum level 108 of aqueous ozone provides a back pressure which ensures that the pressure inside the chamber 101 is greater than pressure outside the chamber 101. Periodically, when the pressure in the headspace gets too high, the pressure release valve 113 releases some of the gas in the headspace out of the chamber 101, which may be fed back into the system 122 via the Venturi injector 116 or simply exhausted.

In operation, the force of the mixture hitting the impingement member 105 and the resultant splashing of the mixture causes some ozonated air in the mixture to be plunged into the aqueous ozone which forms bubbles 120. Some of the ozone in the bubbles is absorbed into the aqueous ozone 118, thus increasing the amount of dissolved ozone by submersion and hydraulic pressure.

The droplets 117, mist and foam 121 of the aqueous ozone dispersed by the splashing into the headspace increase the contact area between the ozonated air in the headspace and the aqueous ozone, i.e. instead of gas-in-liquid mixing, there is a liquid-in-gas dispersion. Consequently, more ozone is absorbed into the aqueous ozone by the increase in interface area. The foam head 121 on the surface of the water and the thin film of water 114 on the wall of the chamber 101 also enlarges the gas-liquid interface and thus also increase ozone absorption. As the dispersed droplets/mist 117 in the headspace falls/settles to towards the body of aqueous ozone 118 in the chamber 101, there is interaction between the droplets/mist 117 and the ozone in the headspace, which also leads to absorption of more ozone into the aqueous ozone.

The splashing of the mixture, the settling of the droplets 117, mist and foam 121 all contribute to dynamic and spontaneous mixing of ozonated air and aqueous ozone. The concurring increase in ozonated air/aqueous ozone interface area increases the rate of ozone dissolution. In comparison to prior art, the impact based mixing is more dynamic and chaotic and causes better mixing than just mere stirring. The continuous disturbance of ozonated air and water improves total rate of ozone absorption without stirrers or mechanical agitation.

The amount of aqueous ozone 118 inside the chamber 101 is related to a period of ‘residence time’ (or settling time), which is a delay period during which a specific volume of aqueous ozone 118 settles in the chamber 101 despite continuous discharged through the outlet 103. The delay provides residence time for sufficient ozone dissolution to take place, as well as oxidation and disinfection of the water, and also allows undissolved ozone bubbles that is plunged into the aqueous ozone to redissolve into the depleted aqueous ozone. Therefore, no bubbles are drawn out through outlet 103 at the bottom of the chamber 101 along with the outflow of aqueous ozone. Depending on the amount of residence time, aqueous ozone that is discharge from the mixing apparatus 100 is either totally or partially disinfected and oxidised.

The level 115 of aqueous ozone in the chamber 101 is determined based on the amount of aqueous ozone 118 required to provide sufficient residence time, as well as a sufficient height 109 for impinging and splashing the pre-mix of ozonated air/aqueous ozone onto the impingement member 105.

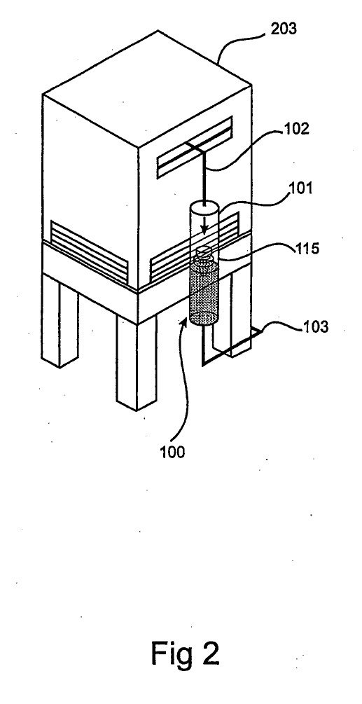

FIG. 1a shows another embodiment, in which the flow control valve 119 of the embodiment of FIG. 1 is removed and an inverted U-shape pipe 123 is connected to the outlet 103. The inverted U-shape pipe 123 has a maximum height at the bend of the inverted U, which corresponds to a predetermined maximum allowable level of aqueous ozone 115 in the chamber 101. The level of aqueous ozone 124 in the upstream arm 125 of the U-shape pipe 123 rises as the level 115 of aqueous ozone in the chamber 101 rises. When the level 115 of aqueous ozone in the chamber 101 rises above the height of the bend of the inverted U-shape pipe 123, aqueous ozone in the upstream arm 125 flows over the bend and accordingly reduces the aqueous ozone level 115 in the chamber 101. In this way, a maximum limit is set on the level 115 of aqueous ozone in the chamber 101. The pipe 123 is optionally made of rigid or flexible material (like a hose). If the pipe 132 is made of a flexible material, the height of level 115 can be dynamically adjusted by adjusting the height of the inverted U-shape pipe 123. The U-shape pipe 123 has predetermined dimensions such that the mass flow of liquid through the pipe 132 is not sufficient to create a siphoning effect on the body of aqueous ozone 118 in the chamber 101. FIG. 2 shows a schematic diagram illustrating how a mixing apparatus 100 of FIG. 1 is installed at the side of a cooling tower 203. Coolant water which was cooled in the cooling tower is injected with ozone and is piped at 102 to the mixing apparatus 100. The mixing apparatus 100 aids in the mixing and dissolution of ozone as described before and releases the ozonated water which is piped at 103 back into a process downstream of the cooling tower.

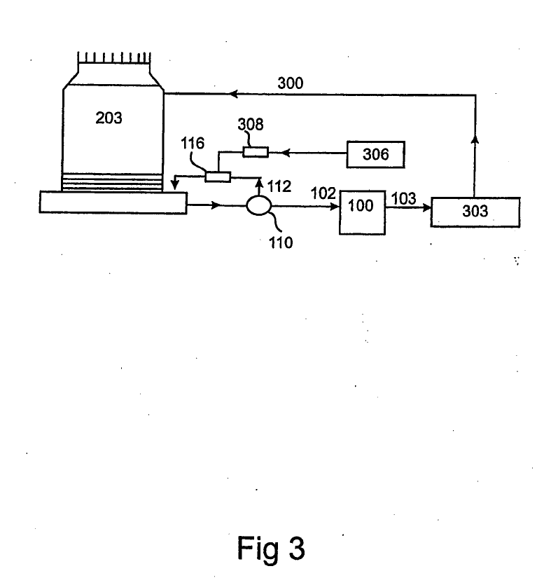

FIG. 3 shows a schematic illustration of the cooling system 300 of cooling tower 203 of FIG. 2. As described earlier, the cooling tower 203 works by fanning air upward and against a cascading fall of water that has been warmed in a heat exchange process (not shown). A reflux stream is piped off from a main stream of coolant water at a pump 110 to become the water stream 112 of FIG. 1 used to draw in ozonated air from the Venturi injector 116. The ozonated air is generated in an ozone generator 308 from ambient air 306. The Venturi injector 116 ensures that the ozonated air is mixed with the reflux stream of water 112. However, ozonated air does not easily dissolve in water. Thus, the mixing apparatus 100 as described above is disposed between the pump 110 and the condenser 303 to mix and dissolve the ozonated air into the water. As a result, only disinfected water reaches the condenser 303 which is downstream of the mixing apparatus 100. Depending on the operating condition, residual ozone disinfecting and oxidising effects in the water released from the mixing apparatus 100 also clean the cooling system 300.

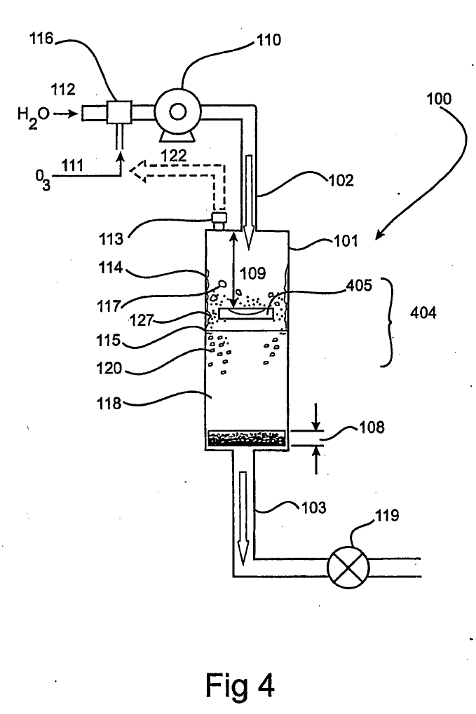

FIG. 4 shows another embodiment of the mixing apparatus 400. All the parts of the embodiment in FIG. 4 corresponds to the parts of the embodiments of FIG. 1 except for the absence of a floating element 107 and movement stabiliser 106; the reflector assembly 404 comprises only an impingement member 405. The position of the impingement member 405 is fixed in the chamber 101 instead of depending on the aqueous ozone level 115 in the chamber 101. The fixed impingement member 405 thus provides a sturdier surface for impingement than the impingement member 105 in the first embodiment, which bobs on the surface 115 of the aqueous ozone. In this embodiment, the level 115 of aqueous ozone in the chamber 401 has to be kept below the impingement member 405 so as not to submerge the impingement member 405.

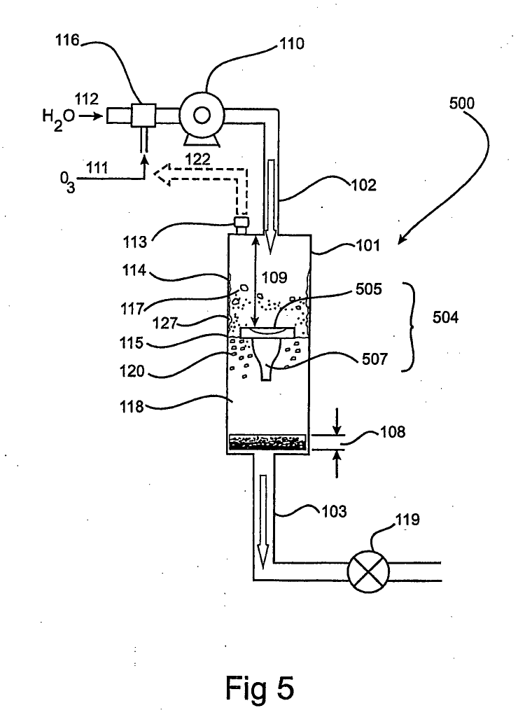

FIG. 5 shows yet another embodiment of the mixing apparatus 500 wherein the reflector assembly 504 has an impingement member 505 and float 507 but has no stabiliser 106.

As the embodiments facilitates dissolution of ozone by increased partial pressure as well as by increased interface area between gas and liquid, the embodiments are able to improve ozonation of water in ambient temperature.

In a variation of the embodiments, dedicated inlets introduce gas and liquid separately into the chamber, i.e. the gas and liquid are not introduced pre-mixed into the mixing apparatus.

In yet another embodiment, several fixed impingement members are used to create a cascading splashing effect. The bottom-most impingement member in such a series of impingement members is optionally floating on the surface of the aqueous ozone, as with the assembly 104 of the first embodiment in FIG. 1.

In yet another embodiment, the outlet flow control comprises both an inverted U-shape pipe 132 as well as a flow control valve 119.

In yet another embodiment, the ozonated air-aqueous ozone mixture is pumped into the chamber with a configuration such that the jet of mixture hits a wall or other part of the chamber instead of an impingement member, the impact providing the dynamic and spontaneous mixing and the increase in interface area between gas and liquid.

In yet another embodiment, the mixing apparatus mixes ozone and water in batches instead of a continuous process.

In yet another embodiment, with a suitably chosen pressure for the water jet, the surface 115 of the aqueous ozone 118 may be used as the impingement member.

Other than mixing ozone and water, the described mixing apparatus 100 may be used for dissolution of other gases in other liquids. In some applications, the substances introduced into the chamber 101 at the inlet 102 do not form a gas/liquid pre-mix, but form a liquid/liquid or a solid/liquid pre-mix. An example of a process where the input substances form a solid/liquid pre-mix is the dissolution of a salt in water.

Other than a dissolution process, the described embodiments can also be used to mix substances for processes such as diffusion, emulsification, homogenisation, chemical reactions (such as polymerisation), forming a colloid or even making a suspension mixture (e.g. a suspension which results from a precipitation reaction). In any process, at least one of the substances is liquid.

It should be understood that the embodiments described herein are but embodiments of underlying concepts of the invention. Alternatives to the embodiments, though not described, are intended to be within the scope of this invention as claimed.

1. A mixing apparatus for mixing a liquid and another substance, the apparatus comprising:
a container having at least one inlet for introducing the liquid and the other substance into the container;
an outlet arranged to release a mixture of the substances from the container and thereby to control the level of mixture in the container; and
an inpingement member arranged to remain above the level of the mixture and providing a surface inside the container against which the liquid and the other substance are arranged to splash.

2. A mixing apparatus as claimed in claim 1 wherein the container has a wall and the splashed liquid forms a film of liquid on the wall of the container.

3. A mixing apparatus as claimed in claim 1 wherein the apparatus is arranged, in use, such that the inlet is above the surface.

4. A mixing apparatus as claimed in claim 1 further comprising a means of retaining a pre-determined amount of the mixture in the container.

5. A mixing apparatus as claimed in claim 4 wherein the means of retaining a predetermined amount of the mixture in the container comprises a regulating valve connected to the outlet.

6. A mixing apparatus as claimed claim 1 wherein the impingement member is arranged to float on the mixture.

7. A mixing apparatus as claimed in claim 6 further comprising a float connected to the inpingement member.

8. A mixing apparatus as claimed claim 6 further comprising a guiding member arranged to guide movement of the inpingement member in the container.

9. A mixing apparatus as claimed in claim 5 wherein the impingement member has a fixed position in the container.

10. A mixing apparatus as claimed in claim 1 further comprising a pump arranged to introduce the liquid into the container.

11. A mixing apparatus as claimed claim 1 wherein the other substance is selected from a gas, liquid or solid.

12. A mixing apparatus as claimed claim 1 wherein the liquid and the other substance are soluble one into the other.

13. A mixing apparatus as claimed claim 1 wherein the mixture is a solution, suspension, colloid or emulsion of the liquid and the other substance.

14. A mixing apparatus as claimed claim 1 wherein the liquid is water and the other substance comprises ozone.

15. A method for mixing a liquid and another substance comprising the steps of
introducing the liquid and the other substance into a container, the container having an impingement member;
directing the liquid towards the impingement member so that the liquid and the other substance splash to form a mixture; and
releasing the resulting mixture from the container such that the mixture remains at a level below the impingement member.

16. A method as claimed in claim 15 wherein the splashed liquid forms a film of the liquid on the wall of the container.

17. A method as claimed in claim 15 wherein the amount of the mixture retained provides a predetermined period of residence time in the container for the mixture before the mixture is released to a downstream process.

18. A method as claimed claim 15 wherein the impingement member floats on the surface of the mixture.

19. A method as claimed in claim 15 further comprising the step of
providing a predetermined distance between an inlet means through which the liquid and the substance enter the container and the impingement member.

20. A method as claimed in claim 15 wherein the supply of liquid and the substance is continuous.

21. A method as claimed in claim 15 wherein the other substance is selected from a gas, liquid or solid.

22. A method as claimed in claim 15 wherein the mixture is a solution, suspension colloid or emulsion of the liquid and the other substance.

23. A method as claimed in claim 15 wherein the mixing causes a chemical reaction between the substances.

24. A method as claimed in claim 23 wherein the reaction is a precipitating chemical reaction between the substances.

25. A method as claimed in claim 15 wherein the liquid is water and the other substance is a gas mixture containing ozone.
